(19) United States
(12) Patent Application Publication
(10) Pub. No.: US 2005/0015878 A1
(43) Pub. Date: Jan. 27, 2005

(54) Surgical tables

(76) Inventors: Grahame David Bannister, Burgess Hill (GB); Mark Allen Seidler, Worthing (GB); Peter James Briggs, Lancing (GB)

Correspondence Address: LOUIS WOO;LAW OFFICE OF LOUIS WOO, 717 NORTH FAYETTE STREET, ALEXANDRIA, VA, 22314, US

(21) Appl. No.: 10/491,824

(22) PCT Filed: Oct. 7, 2002
(86) PCT No.: PCT/GB02/04543

(30) Foreign Application Priority Data
Oct. 8, 2001 (GB) 0124126.4

(51) Int. Cl. A61G 13/08

(52) U.S. Cl. 5/618; 5/610

(57) ABSTRACT

A surgical table comprising a base for standing on a floor, a column of adjustable height mounted on the base, a tabletop providing a patient support surface, a movable framework mounted between the tabletop and the column for enabling at least a part of the tabletop to be rotatable about two orthogonal axes, the movable framework comprising first and second framework, and first and second actuators, each actuator being connected to a respective frame portion for moving the respective frame portion about a respective axis.

Surgical tables comprising a base for standing on the floor, a column of adjustable height mounted on the base and a tabletop providing a patient support surface are well known. The table usually has some mechanism for adjusting the angle of the top, which is commonly divided into several separate sections, the angle of which relative to one another can be varied.

There is a need for providing an improved mechanism for varying the angle of the tabletop.

Furthermore, the surgical tables need periodically to be cleaned so as to remove any contamination therefrom. Also, the mechanical, electrical and electronic components of the surgical table need to be periodically serviced. There is also a need for a surgical table in which access to various parts of the table for the purpose of servicing is improved.

Surgical tables are also known where the height adjusting mechanism of the column for varying the height of the tabletop includes relatively movable members in combination with a lifting mechanism. There is a still further need for a surgical table having an improved column lifting mechanism. It is essential that the column retains its structural rigidity whilst being varied in height.

In order for surgical tables to be versatile, it is necessary for the tabletop to be disposable in a variety of different configurations. There is a need for a surgical table having a movable tabletop to increase the variety of configurations to which the tabletop may be disposed.

When the tabletop is moved from one configuration to another, it is necessary to ensure that the medical staff using the surgical table are not injured as a result of relative movement of various parts of the table. Accordingly, there is a need for a surgical table having inbuilt safety devices to prevent medical staff being injured, for example by fingers of the medical staff being trapped in relatively movable parts of the table.

Surgical tables need to be movable over a floor and to this end known tables have wheels or castors together with braking assemblies to enable them to be moved and to be secured in position. It is necessary for the wheels and castors to bear the weight of the table, which may also require the weight of heavy patients to be carried, while still providing stability during surgical procedures. There is a need for an improved wheel/castor assembly for a surgical table.

In a first aspect the present invention provides a surgical table comprising a base for standing on a floor, a column of adjustable height mounted on the base, a tabletop providing a patient support surface, a movable framework mounted between the tabletop and the column for enabling at least a part of the tabletop to be rotatable about two orthogonal axes, the movable framework comprising first and second frame portions of the framework, and first and second actuators, each actuator being connected to a respective frame portion for moving the respective frame portion about a respective axis.

Preferably, the first frame portion is rotatably mounted on the column about a first axis and the second frame portion is rotatably mounted on the first frame portion about a second axis and is connected to the tabletop.

Preferably, the first frame portion is disposed within the second frame portion and the first frame portion surrounds a top part of the column.

Preferably, the first frame portion is rotatably mounted on the column by two first pivot joints on opposed sides of the column.

Preferably, the two first pivot joints are located at a height below the top of a lifting mechanism for the column.

Preferably, the second frame portion is rotatably mounted on the first frame portion by two pivot joints, which are on opposed sides of the first frame portion.

Preferably, each of the first and second actuators comprises a fixed body part mounted on one of the column and the respective frame portion and a movable elongate part connected to the other of the column and the respective frame portion.

Preferably, the movable elongate part is connected to the respective frame portion by a universal joint.

Preferably, each frame portion is rectangular and the movable elongate part is connected to a corner part of the respective frame portion

Preferably, the fixed body part of each actuator is mounted on a frame of the column, which is adapted to change height together with the tabletop when the height of the tabletop is adjusted.

Preferably, the tabletop is attached to opposed longitudinally directed members of the second frame portion.

In a second aspect the present invention provides a surgical table comprising a base for standing on a floor, a column of adjustable height mounted on the base, a tabletop providing a patient support surface, and a hinge mechanism between the top of the column and the tabletop to enable the tabletop to be hinged upwardly to reveal the top of the column and the underside of the tabletop.

Preferably, the hinge mechanism has a hinge axis transverse to the longitudinal direction of the tabletop.

Preferably, the hinge mechanism is mounted on the underside of the tabletop at a position selected to provide substantially equal portions of the weight of the tabletop on opposed sides of the hinge mechanism.

Preferably, the hinge mechanism is mounted to a pair of longitudinally oriented members mounted on the underside of the tabletop and to a movable framework which is mounted between the tabletop and the column for enabling at least a part of the tabletop to be rotatable about two orthogonal axes.

Preferably, the surgical table further comprises at least one catch member between the table and the column for selectively locking the tabletop in a down position.

Preferably, the hinge mechanism and the at least one catch member are located at opposed transverse sides of the column.

In a third aspect the present invention provides a surgical table comprising a base for standing on a floor, a column of adjustable height mounted on the base and a tabletop providing a patient support surface, the column comprising an inner column portion mounted on the base and including a lifting mechanism, an outer column portion having a top part mounted to a movable top part of the inner column and movable therewith, the outer column portion being connected to the tabletop, and a slider assembly between the inner and outer column portions.

Preferably, the slider assembly comprises a plurality of slider members mounted on one of the inner and outer column portions, which are arranged to slide over at least one surface of the other of the inner and outer column portions.

Preferably, the slider members are mounted on the inner surface of the outer column portion and bear against the outer surface of the inner column portion.

Preferably, the slider members are mounted along a lower edge of the outer column member.

Preferably, the outer column portion is tubular and the slider members are mounted around the inner surface of the tube,

Preferably, the outer column portion is mounted to the inner column portion by a horizontal plate, which is affixed to a horizontal top surface of the lifting mechanism and to an upper peripheral edge of the outer column portion.

Preferably, the slider members comprise plastics pads.

Preferably, the plastics is acetal homopolymer.

Preferably, the plastics pads are mounted in adjustable mounts so that the plastics pads are adjustable to compensate for wear of the pads.

In a fourth aspect the present invention provides a surgical table comprising a base for standing on a floor, a column of adjustable height mounted on the base, a tabletop providing a patient support surface, and a tabletop traverse drive mechanism for moving the tabletop relative to the column in a selected longitudinal direction of the tabletop.

Preferably, the tabletop traverse drive mechanism comprises a motor, a pair of drive elements for being driven by the motor, and a pair of traverse devices, each respective traverse device being located at a respective longitudinal edge of the tabletop, each drive element being adapted to drive a respective traverse device.

Preferably, each traverse device comprises an elongate first coupled member extending in a longitudinal direction of the tabletop, a body movable along the first coupled member and an annular second coupled member mounted in the body and surrounding and engaging with the first coupled member, the respective drive element connecting with the second coupled member.

Preferably, the first and second coupled members are threaded and are meshed together.

Preferably, the motor, the pair of drive elements, the pair of bodies and the pair of second coupled members are mounted in a common frame.

Preferably, the common frame is connected to the column, and the first coupled members are connected to the tabletop.

Preferably, each drive element comprises portions of a common endless belt and the motor includes a pulley assembly for simultaneously driving the endless belt.

Preferably, the endless belt has a profiled inner surface mating with a corresponding profiled outer surface of each annular second coupled member.

Preferably, a respective slider bar is mounted parallel to each first coupled member.

Preferably, each first coupled member and the associated slider bar are mounted between a respective pair of support blocks, which are connected to the tabletop.

In a fifth aspect the present invention provides a surgical table comprising a base for standing on a floor, a column of adjustable height mounted on the base, a tabletop providing a patient support surface, the tabletop being movable relative to the column in at least one selected direction of the tabletop and a finger safety device for protecting the fingers of a user from being trapped between the tabletop and the column during relative movement therebetween.

Preferably, the finger safety device comprises a movable element disposed adjacent one of two opposed surfaces which can move together when the tabletop and the column are moved together, and the movement of the tabletop and the column being disabled when the element is moved.

Preferably, the element is spaced from the said one surface by a particular distance so as to be moved when a user's finger is pushed therebetween.

Preferably, the movable element is provided at each opposed side, with reference to the movement of the tabletop, of the column on each opposed longitudinal edge of the tabletop.

Preferably, a pair of the movable elements is comprised in a respective common detector device for each longitudinal edge of the tabletop.

Preferably, the common detector device comprises a bar having a central portion carrying a switch actuator, and two opposed end portions, each of which comprises a respective movable element, the switch actuator engaging with a switch device whereby movement of the bar in either longitudinal direction causes the switch device to be tripped.

Preferably, the common detector device is mounted between opposed walls of a frame and further comprises a pair of opposed biasing elements for biasing the switch actuator to a central position.

Preferably, the end portions of the bar are horizontally oriented and extend inwardly towards the central longitudinal axis of the tabletop spaced from respective transversely directed outer surfaces of the respective opposed walls.

Preferably, the switch actuator comprises a profiled surface having a central part, and two outer parts, a dimension of the parts progressively increasing from the central part to the outer parts whereby the switch device is moved to trip the switch when the switch device is moved from the central part.

Preferably, the profiled surface also has two intermediate parts between the central part and the outer parts, each intermediate part being on a respective opposed side of the central part.

In a sixth aspect the present invention provides a surgical table comprising a base for standing on a floor, a column of adjustable height mounted on the base and a tabletop providing a patient support surface, the base having first and second opposed ends, a plurality of longitudinally oriented fixed wheels at the first end and a plurality of first castors at the second end for permitting the table to be moved over a floor, a plurality of second castors at the first end, a first moving mechanism for moving the second castors between an upper retracted position and a lower active position, in the lower position the second castors being lower than the fixed wheels whereby the fixed wheels are retracted from the floor, a plurality of fixed feet at the second end and a second moving mechanism for moving the first castors between an upper retracted position and a lower active position, in the lower position the first castors being lower than the fixed feet whereby the fixed feet are retracted from the floor.

Preferably, at least one of the moving mechanisms includes a horizontal member from which the respective castors depend downwardly, at least one guide member for guiding vertical movement of the horizontal member between upper and lower positions and an actuator for selectively applying a downwardly directed force to the horizontal member to move the respective castors to the lower active position.

Preferably, the actuator comprises a bearing member eccentrically mounted on a first end of a rotatable shaft member, the bearing member having a bearing surface acting on the upper surface of the horizontal member, an arm mounted on and extending radially away from an opposed second end of the shaft member and a pedal member mounted on an end of the arm remote from the shaft.

Preferably, the bearing member comprises a roller bearing and the horizontal member is a plate.

Preferably, the at least one guide member comprises a plurality of upwardly directed guide pins extending through respective holes in the plate.

Preferably, the at least one moving mechanism further comprises a locking mechanism for locking the actuator in a downward position and to retain the respective castors in the lower active position.

Preferably, the locking mechanism includes an outwardly extending bracket mounted on the base and providing a downwardly facing locking surface against which an upper surface of the arm is selectively retained.

Preferably, the at least one moving mechanism further includes a damping device for damping the movement of the base when the respective castors are retracted.

Preferably, the damping device comprises a hydraulic damper.

Preferably, the two moving mechanisms have the same structure and the pedals of the two moving mechanisms are disposed at a common longitudinal edge of the base.

The preferred embodiments of the present invention will now be described by way of example only with reference to the accompanying drawings, in which:

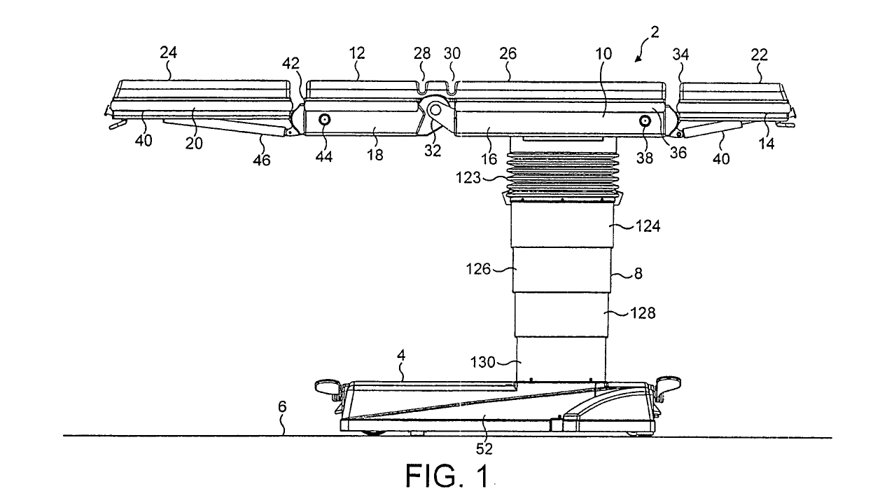

FIG. 1 is a schematic side view of a surgical table in accordance with an embodiment of the present invention;

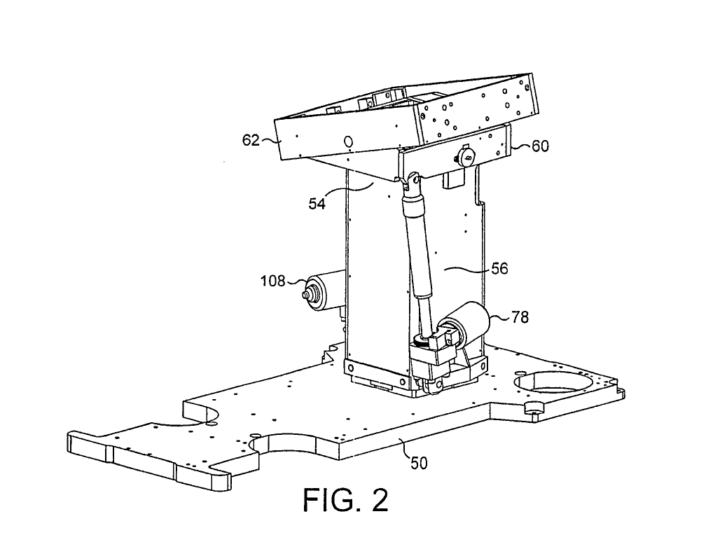

FIG. 2 is a schematic perspective view of part of the surgical table of FIG. 1 showing a tilt/trend mechanism;

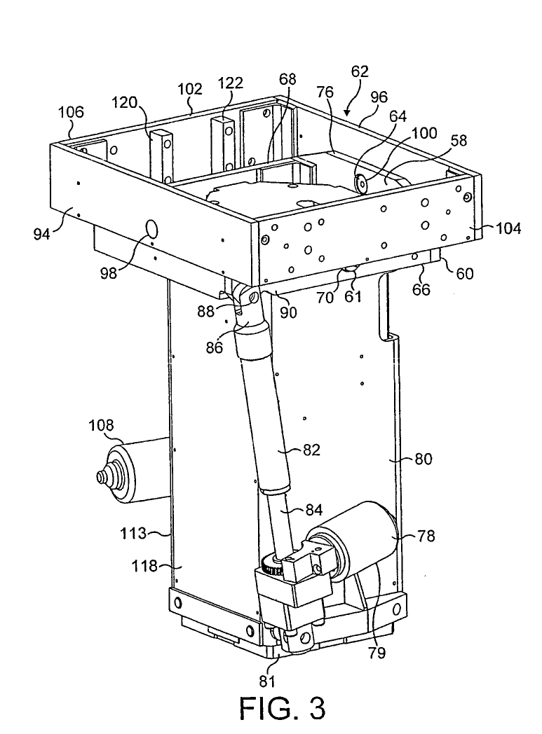

FIG. 3 is an enlarged schematic view of part of the tilt/trend mechanism of FIG. 2;

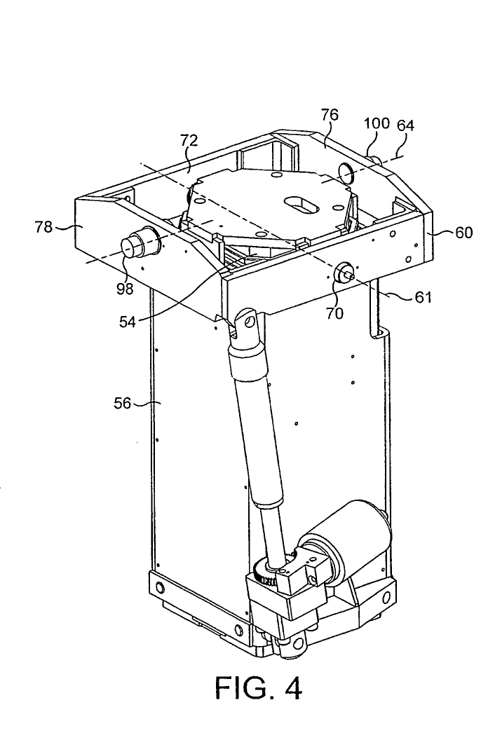

FIG. 4 is an enlarged schematic view of part of the tilt/trend mechanism of FIG. 2 with the tilt frame removed;

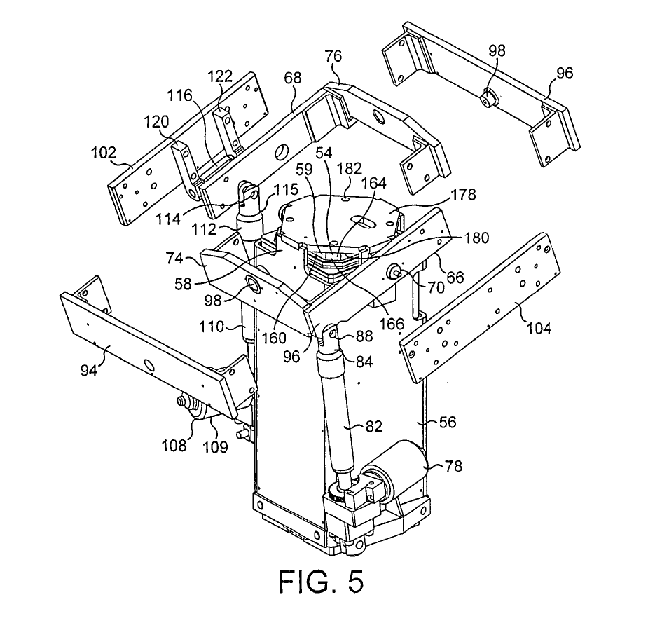

FIG. 5 is an exploded schematic view of the tilt and trend frames of the tilt/trend mechanism of FIG. 2;

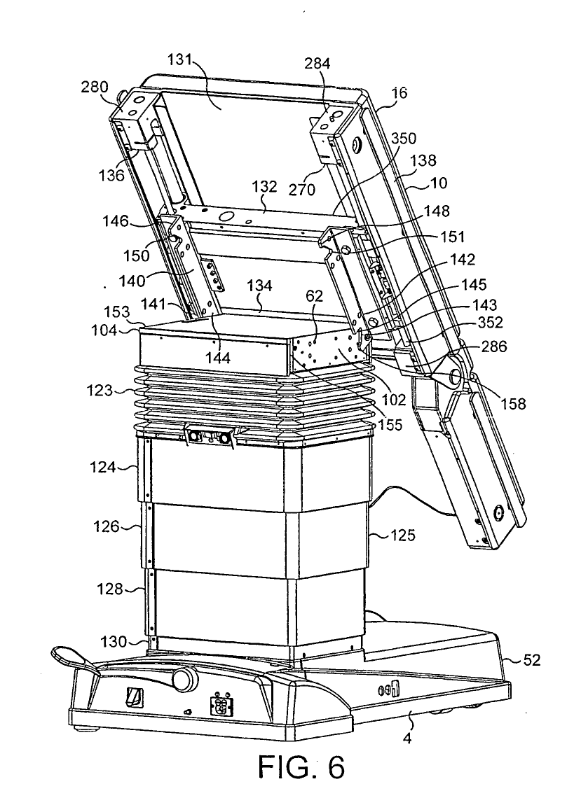

FIG. 6 is a schematic perspective view of part of the surgical table of FIG. 1 showing a hinge mechanism for the tabletop;

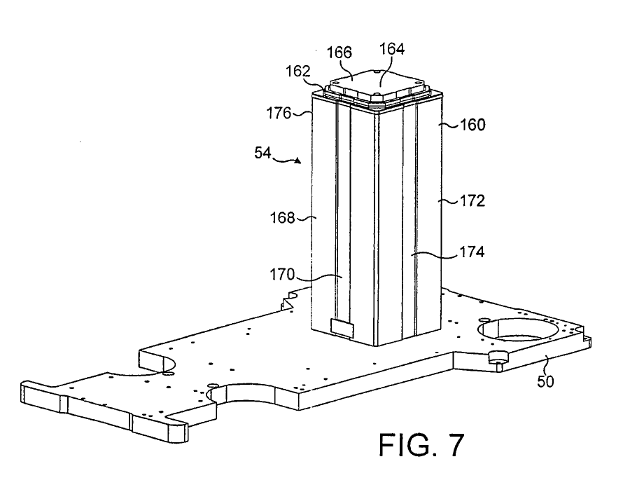

FIG. 7 is a schematic perspective view of part of the surgical table of FIG. 1 showing an inner column mounted on a base;

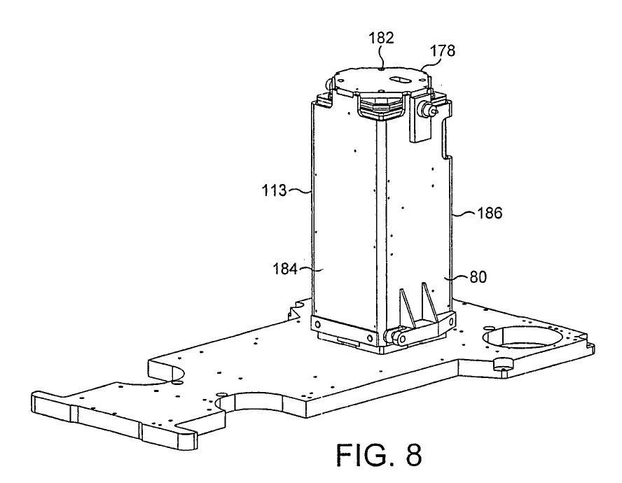

FIG. 8 is a schematic perspective view of part of the surgical table of FIG. 1 showing the outer column surrounding the inner column;

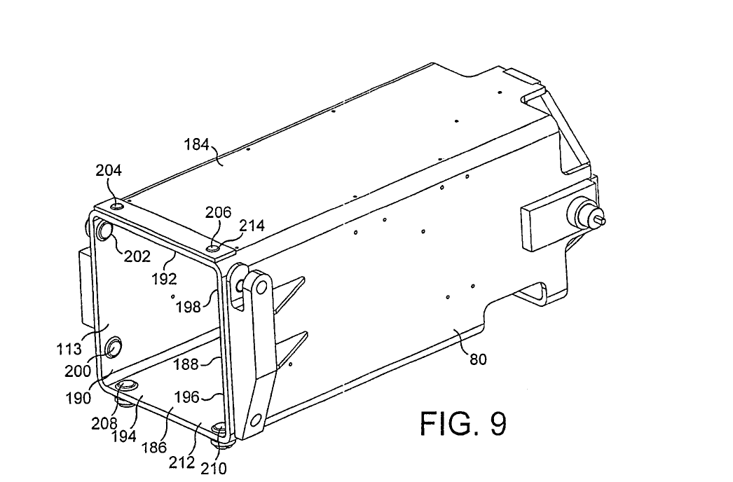

FIG. 9 is a schematic perspective view of the outer column of FIG. 8 in disassembled form;

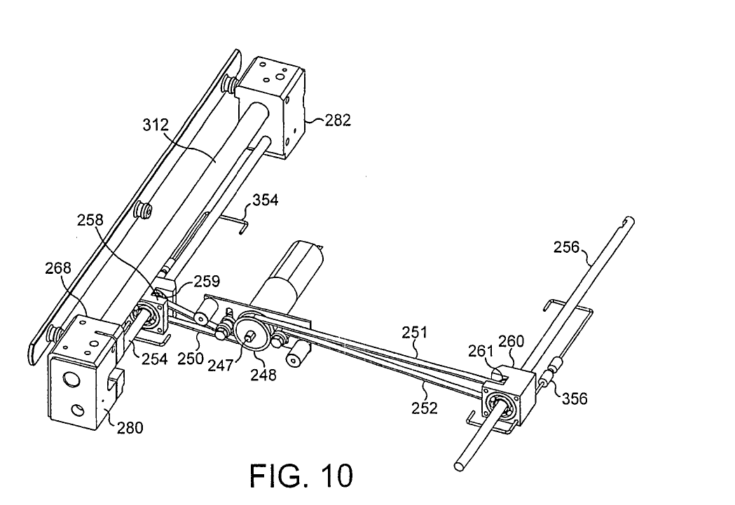

FIG. 10 is a schematic perspective view of part of a traverse mechanism for the tabletop of the surgical table of FIG. 1;

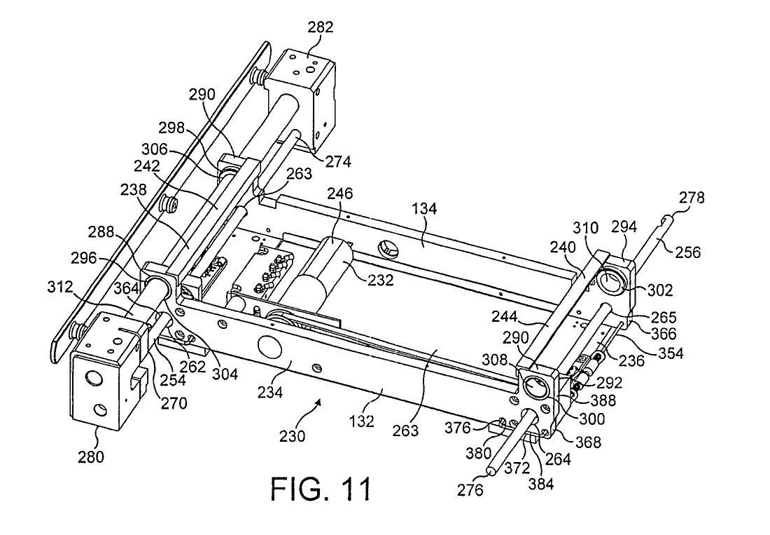

FIG. 11 is a schematic perspective view of part of the tabletop traverse mechanism for the tabletop;

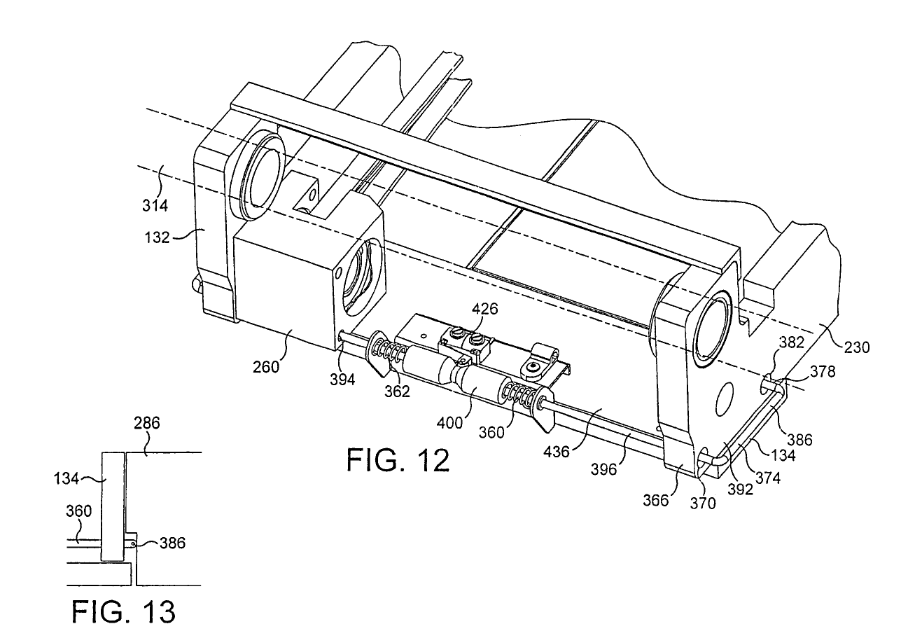

FIG. 12 is an enlarged schematic perspective view of an edge of part of the traverse mechanism;

FIG. 13 is a schematic drawing of the interrelationship between various parts of the traverse mechanism and the tabletop;

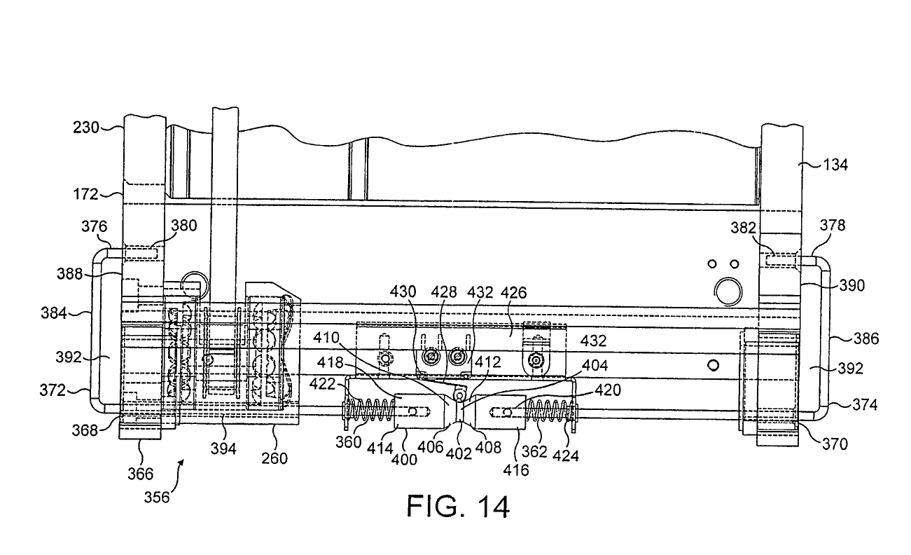

FIG. 14 is a schematic plan of the edge of the traverse mechanism showing a fingertrap switching mechanism;

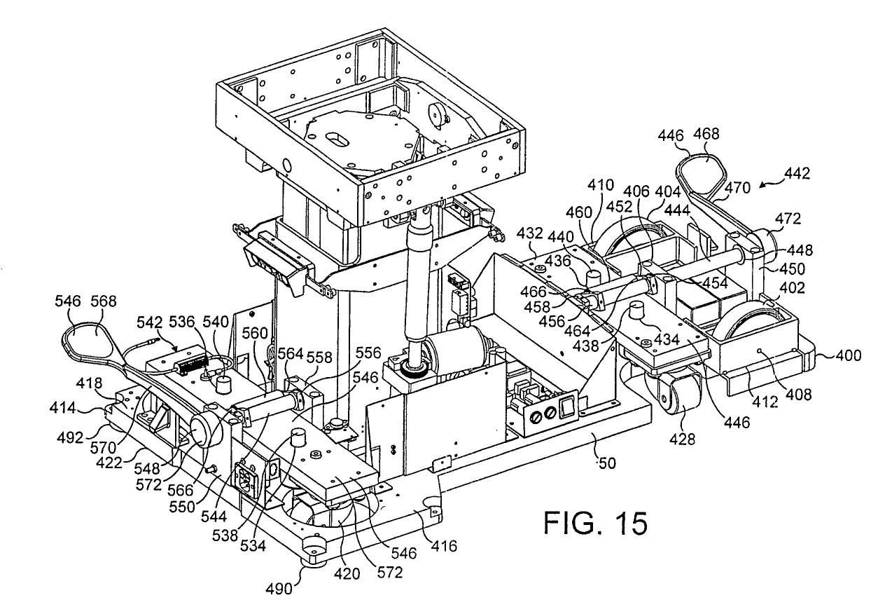

FIG. 15 is a schematic perspective view of part of the surgical table of FIG. 1 showing the wheel and castor arrangement on the chassis;

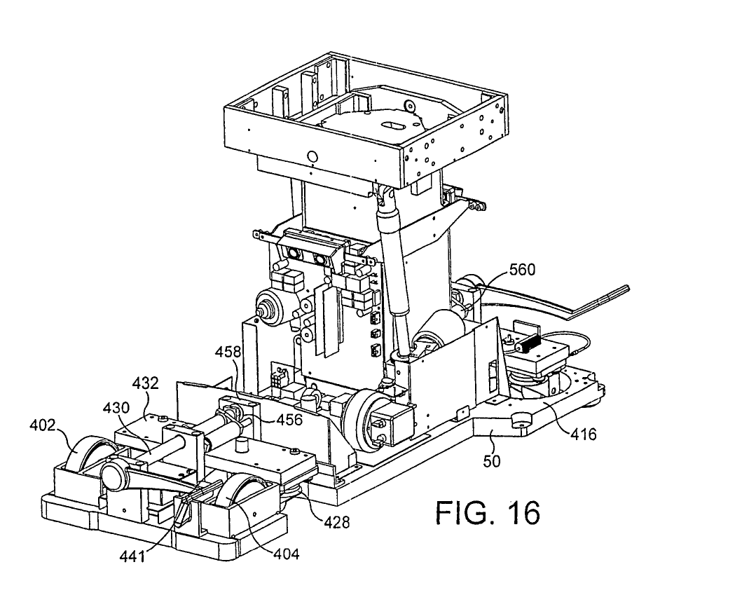

FIG. 16 is a schematic perspective view of part of the surgical table of FIG. 1 showing the wheel and castor arrangement on the chassis;

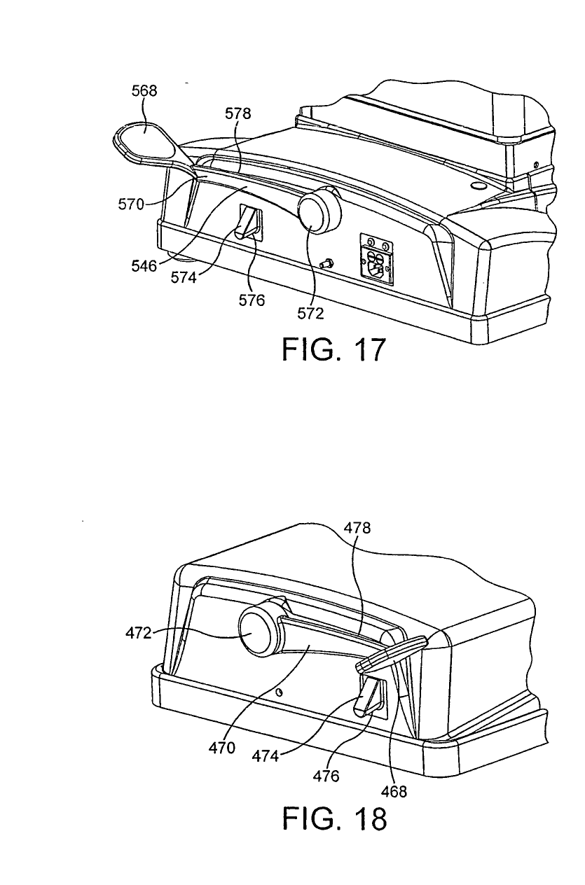

FIG. 17 is a perspective view of one end of the base of the surgical table of FIG. 1; and

FIG. 18 is a perspective view of the other end of the base of the surgical table of FIG. 1.

Referring to FIG. 1, the surgical table, designated generally as 2, includes a base 4, which stands on the floor 6, a column 8 of adjustable height mounted on the base 4 and a tabletop 10 providing a patient support surface 12.

The tabletop 10 is divided into four sections, namely a head section 14, an upper torso section 16, a lower torso section 18 and a leg section 20. The head and leg sections 14,20 each have a respective separate mattress 22,24. The upper and lower torso sections 16,18 have a common mattress 26 extending along the length of both sections 16,18. The common mattress 26 is provided with a pair of spaced parallel grooves 28,30 extending transversely across the width of the tabletop 10 above the location of a first pivot joint 32 between the upper and lower torso sections 16,18. This permits flexing of the common mattress 26 when the upper and lower torso sections 16,18 are relatively inclined to each other by pivoting about a transverse axis defined by the pivot joint 32, as will be described in detail hereinafter.

A lower end 34 of the head section 14 is mounted on an upper end 36 of the upper torso section 16 by means of a second pivot joint 38 defining a transverse axis about which the head section 14 can be displaced relative to the upper torso section 16. The angle of inclination of the head section 14 is controlled by means of a pair of conventional adjustable struts 40, only one of which is shown in FIG. 1, secured to and extending between the underside of the head section 14 and the upper torso section 16, one on each side of the tabletop 10. The struts 40 may be hydraulic or electric actuators or lockable gas springs. The leg section 20 is similarly mounted at a lower end 42 of the lower torso section 18 for displacement about a transverse axis defined by a third pivot joint 44 by means of two struts 46, only one of which is shown, secured at opposite ends thereof to the lower torso section 18 and the leg section 20.

The provision of the three pivot joints 32,38,44 permits the four sections 14,16,18,20 selectively to be inclined relative to adjacent sections 14,16,18,20 thereby to dispose the tabletop 10 in a selected configuration.

In accordance with one aspect of the present invention, the surgical table 2 is provided with a trend/tilt mechanism to enable both the upper torso section 16 of the tabletop 10 to be inclined relative to the horizontal about a transverse axis across the table 2 (by the trend mechanism) and the entire tabletop 10 to be inclined relative to the horizontal about a longitudinal axis extending along the length of the tabletop 10 (by the tilt mechanism). More particularly, the upper torso section 16 is mounted to a framework which is adapted to be movable, by operation of a drive mechanism, relative to the horizontal to enable the upper torso portion 16 to be moved about either or both of two orthogonal axes.

Referring to FIGS. 2 to 5, these drawings show various parts of the table 2 in disassembled form for ease of explanation. A chassis 50 of the base 4 has mounted thereto and extending upwardly away therefrom an adjustable lifting column mechanism 54 of the column 8. The chassis 50 is covered, in the assembled table 2, with a cover member 52 as shown in FIG. 1. The column mechanism 54 includes a tubular wraparound frame 56 which is vertically oriented and has a rectangular, preferably square, section. The wraparound frame 56 typically comprises steel sheets which have been welded together to form a rigid body. An upper part 58 of the wraparound frame 56 is attached, for example by being bolted, to a top part 59 of the lifting column mechanism 54. Accordingly, when the lifting column mechanism 54 is increased in height, thereby to raise the height of the tabletop 10 in the manner described hereinbelow, the wraparound frame 56 is raised together with the top part 59 of the lifting column mechanism 54.

As shown in detail in FIG. 3, an inner trend frame 60 is pivotally attached about a horizontal first pivotal axis 61 to the wraparound frame 56 and an outer tilt frame 62 is in turn pivotally attached to the inner trend frame 60 about a second pivotal axis 64. The trend frame 60 is rectangular, preferably square, in shape and comprises a pair of longitudinally oriented opposed pivotal members 66,68, each pivotally attached to the wraparound frame 56 by a respective pivot joint 70,72, with the members 66,68 being connected together at their ends by a pair of transversely oriented opposed side members 74,76. The pivotal members 66,68 permit the trend frame 60 to be rotated about the horizontal axis 61.

The rotation of the trend frame 60 is achieved by operation of a trend actuator 78, typically a hydraulic or electric actuator, which has a body 79 rigidly connected to a frame wall 80 at a base part 81 of the wraparound frame 56. The trend actuator 78 is (in the illustrated embodiment) an electric actuator comprising a fixed body 82, including an electric motor, and a movable elongate leadscrew 84 drivable by the motor with the free end 86 of the leadscrew 84 being rotatably connected, by a joint 88, to a corner 90 of the trend frame 60. In an alternative embodiment, the trend actuator 78 includes a hydraulic assembly comprising a cylinder 82 having a movable piston 84 therein with the free end 86 of the movable piston 84 being rotatably connected, by the joint 88, to the corner 90 of the trend frame 60. The free end 86 may be connected to a mid point of the trend frame 60. Selective actuation of the trend actuator 78 causes the leadscrew 84 to be selectively extended or retracted, thereby causing corresponding rotation of the trend frame 60 about the axis 61 by operation of the pivot joints 70,72.

The outer tilt frame 62 comprises two transversely oriented opposed pivotal members 94,96, which are each pivotally attached by a respective pivot joint 98,100 to a respective side member 74,76 of the inner trend frame 60, whereby the outer tilt frame 62 can rotate about the second pivotal axis 64 defined by the pivot joints 98,100. Like the inner trend frame 60, the outer tilt frame 62 is rectangular, preferably square, in shape, with the opposed pivotal members 94,96 being connected together at their ends by a pair of longitudinally oriented opposed side members 102,104. The top surfaces of each of the two pivotal members 94,96 and the two side members 102,104 of the outer tilt frame 62 lie in a common plane, thereby to define an uppermost mounting surface 106 of the lifting column mechanism 54 upon which the lower surface of the tabletop 10 is mounted.

A tilt actuator 108 having a fixed body 109 of an electric actuator assembly 110 and a leadscrew 112, similar to that for the trend actuator 78, is mounted on the wraparound frame 56, and in particular on a frame wall 113 of the wraparound frame 56 opposite to the frame wall 80 on which the trend actuator 78 is mounted. The leadscrew 112 has a free end 115 which is connected via a universal joint 114 to a connecting member 116 mounted on two downwardly depending support members 120,122 which are fixed to that side member 102 of the outer tilt frame 62 which is located above the tilt actuator 108.

The upper part 58 of the wraparound frame 56 therefore holds the pivot axis 61 for the trend frame 60, which is the inner of the two trend and tilt frames 60,62, and a base part 81 of the wraparound frame 56 acts as the support for both the trend actuator 78 and the tilt actuator 108. The trend frame 60 pivots about the first pivotal axis 61 extending across the width of the tabletop 10 and provides the trend movement for the upper torso portion 16 of the tabletop 10 when the trend actuator 78 is operated. The outer tilt frame 62 is pivotally connected to the trend frame 60 about the second pivotal axis 64 which is at 90° to the first pivotal axis 61 of the trend frame 60. The outer tilt frame 62 provides the tilt movement for the upper torso portion 16, and thereby the entire tabletop 10, about the second pivotal axis 64 extending along the length of the tabletop 10 when rotated by the tilt actuator 108 around its respective pivot joints 98,100 defining the second pivotal axis 64.

Accordingly, the inner trend frame 60 and the outer tilt frame 62 form a gimbal arrangement, about the two orthogonal pivotal axes 61,64, allowing any combination of trend and tilt inclination of the tabletop 10 to be selected by orientation of the two trend and tilt actuators 78, 108.

Since the inner trend frame is disposed within the outer tilt frame, the inner trend frame surrounds a top part of the column and the two pivot joints for the inner trend frame are located at a height below the top of the lifting mechanism for the column. This provides the advantage that the minimum height of the table can be reduced since the tilt/trend mechanism is dropped down the lifting mechanism.

As described in detail hereinbelow, the outer tilt frame 62 forms the top of the lifting column mechanism 54 and, as shown in FIG. 1, a flexible cover 123 in the form of a bellows, typically of elastomeric material, is directly attached to the periphery of the outer tilt frame 62. Also, a telescopic outer cover 125 for the column 8 is directly attached to the column 8 and downwardly depends therefrom. The bellows 123 are flexible to enable the trend and tilt mechanism reliably to be protected against contamination, irrespective of the degree of inclination of the trend or tilt of the tabletop 10 relative to the column 8. The telescopic cover 125 consists, as shown in FIG. 1, of a series, in the illustrated embodiment four, of cover member elements 124,126,128,130 of progressively decreasing cross-section, preferably square, lying successively one within the other in a telescoping arrangement, with the largest dimension element 124 being attached to the column 8 and the other progressively smaller elements 126,128,130 depending downwardly therefrom. The telescopic cover 125 permits the column 8 reliably to be protected against contamination irrespective of the height of the tabletop 10.

The tabletop 10 may be directly bolted to the outer tilt frame 62 or alternatively may be connected thereto via a transfer lock mechanism (not shown). However, as described hereinbelow, in the illustrated embodiment, in accordance with a second aspect of the invention, the tabletop 10 is attached to the top of the column 8 by a hinged construction to allow the tabletop 10 to be hinged upwardly in one direction relative to the column 8 for easy access to the top of the column 8 and the underside of the tabletop 10 during servicing. Following use of the table 2 in an operating theatre, it is intermittently required to move the tabletop 10 relative to the top of the column 8 in order that the electronic, electrical and mechanical components of the height-adjustable tilting column mechanism 54, and also corresponding components on the underside of the tabletop 10, can be accessed easily for periodic servicing.

Referring to FIG. 6 the lower surface 131 of the tabletop 10 is provided with a pair of transversely oriented first cross members 132,134 which are respectively connected at opposed ends thereof (and via a tabletop traverse drive assembly as described hereinafter) to respective longitudinal edges 136,138 of the tabletop 10. In turn, a pair of longitudinally oriented second cross members 140,142 are affixed to the transverse first cross members 132,134 and opposed ends of the longitudinal cross members 140,142 are respectively hingedly attached at one end 141,143 thereof by a pair of hinge joints 144,145 to the side members 104,102 of the outer tilt frame 62. Each longitudinal cross member 140,142 is provided at the opposed ends thereof 146,148 with a respective catch member 150,151 which engages a corresponding catch release member 153,155 on the respective side member 104,102 of the outer tilt frame 62. In FIG. 6 the tabletop 10 is shown in its hinged-open configuration relative to the column 8 in which the catch members 150,151 have been released from the respective catch release members 153,155 on the tilt frame 62.

The hinge joints 144,145 are located beneath the upper torso section 16 of the tabletop 10, and in particular are located at a position so as to act as a fulcrum 158 for the tabletop 10, with substantially equal portions of the weight of the tabletop 10 being on opposed sides of the fulcrum 158. This provides a counterbalance to enable the hinged tabletop 10 readily to be hinged to an open (or up) configuration about the hinge joints 144,145 with minimum manual effort required by the service engineer, thereby reducing the risk of manual handling accidents to the service engineer, allowing one-person servicing and leading to reduced down time in the operating theatre. This avoids two persons being required to lift off the tabletop 10 in order safely to remove the tabletop 10 as is required by known arrangements. When the tabletop 10 is in its closed or hinged-down configuration, the catch members 150,151 securely engage with the release members 153,155 so that the tabletop 10 is securely fitted to the outer tilt frame 62 without danger of inadvertent hinging of the tabletop 10 relative to the column 8.

In accordance with another aspect of the invention, the lifting column mechanism 54 of the column 8 includes a sliding arrangement of inner and outer column members for increasing the stiffness of the column assembly. Since the lifting column mechanism 54 of the column 8 is required to be extendable in order to adjust the height of the tabletop 10, it is important that the column 8 is as far as possible completely rigid, yet readily providing a height extendable lifting column mechanism 54.

In accordance with this aspect of the invention, as shown in FIGS. 7 to 9, an inner column 160 of the lifting column mechanism 54 has disposed therein a hydraulically, pneumatically or electrically operated lifting device 162, for example incorporating a cylinder and piston assembly (not shown). The inner column 160, which is shown at minimum height in FIG. 7, includes a top member 164 defining a flat upper mounting surface 166 and, separate therefrom, an outermost cover member 168 of the inner column 160. The top member 164 is, for example, attached to a piston and the cover member 168 is, for example, attached to a cylinder. The cover member 168 comprises a rectangular, preferably square, section tubular body and is shaped and configured to define a first pair of opposed outer transverse bearing surfaces 170,172 disposed at longitudinally, with respect to the direction of the tabletop 10, opposed sides of the inner column 160 and a second pair of opposed outer longitudinal bearing surfaces 174,176 disposed at transverse sides of the inner column 160. The bearing surfaces 170,172,174,176 are smooth and planar and extend vertically upwardly away from the base chassis 50.

Referring to FIGS. 5 to 8, the lifting column mechanism 54 further includes a rigid top plate member 178 which has a lower surface 180 thereof which is affixed to the upper mounting surface 166 of the inner column 160 by the provision of a plurality of bolts 182 extending downwardly through the plate member 178 into the top member 164 of the inner column 160. The plate member 178 is rigidly affixed to the top edges of the frame walls 80,113, and additional opposed frame walls 184,186 therebetween, of the wraparound frame 56. Referring particularly to FIG. 9 the inner surfaces 188,190,192,194 of the frame walls 80,113,184,186 of the wraparound frame 56 are provided with inwardly directed slider members 196,198,200,202,204,206,208,210 which are configured to extend inwardly of the frame walls 80,113,184,186 and to bear, in a smoothly slidable fashion, against the outer bearing surfaces 170,172,174,176 of the correspondingly adjacent walls of the cover member 168 of the inner column 160.

As shown in detail in FIG. 9, each inner surface 188,190,192,194 of each wall 80,113,184,186 of the wraparound frame 56 is provided along a bottom edge 212 thereof with a pair of laterally spaced slider members 196,198; 200,202; 204,206; 208,210 in the shape of pads. The pads may be composed of a durable plastics material, such as nylon. At least some of the bearing pads 196-210 may be adjustable, via a respective threaded mount 214 therefor on the wraparound frame 56, to enable the pad to be movable inwardly. This can account for wear of the pads 196-210 over time and/or can enable initial adjustment of the pads 196-210 so that they firmly bear against the bearing surfaces 170,172,174,176 of the outer cover member 168 of the inner column 160 in a smoothly sliding arrangement, yet prevent any lateral movement of the wraparound frame 56 relative to the inner column 160 when under non-axial loading.

In accordance with a yet further aspect of the invention, the surgical table 2 includes a traverse drive assembly mounted between the underside of the tabletop 10 and the top of the column 8 for permitting a traverse movement of the tabletop 10 relative to the column 8 in a back or forth longitudinal direction.

Referring to FIGS. 10 to 14, the traverse assembly 230 includes a motor drive assembly 232 which is connected to and disposed between the transverse first cross members 132,134 of the lower surface 131 of the tabletop 10. The cross members 132,134 comprise end members of a support frame 234 for the motor drive assembly 232. The support frame 234 also includes a floor 236 connected to the lower edge of each cross member 132,134. A pair of opposed edge supports 238,240 are connected to opposed upper edges of the cross members 132,134 at respective longitudinal edges 242,244 of the traverse assembly 230. An electric motor 246 of the motor drive assembly 232 is mounted on the floor 236 of the support frame 234. The motor 246 is provided with a drive axle 247 on which is mounted a common pulley assembly 248 which is adapted to drive simultaneously an endless belt 251 having opposed endless belt portions 250,252 each extending towards a respective longitudinal edge 242,244 of the traverse assembly 230. Each endless belt portion 250,252 has received therein at an end remote from the pulley assembly 248 a respective longitudinally directed leadscrew 254,256.

Each leadscrew 254,256 has a helical thread thereof which meshes with a corresponding helical thread provided by a respective drive block 258,260, each of which is mounted for threaded movement along the respective leadscrew 254,256. Each drive block 258,260 is affixed to an inner surface 263 of the cross member 132. The helical thread of each drive block 258,260 is provided at an inner cylindrical surface of a respective drive cog 259,261 of the drive block 258,260, the outer cylindrical surface thereof connecting with the inner surface of the respective endless belt portion 250,252. The inner surfaces of the endless belt portions 250,252 are preferably provided with profiles, for example v-shaped profiles, which engage with corresponding cavities in the outer surface of the drive cogs 259,261 in order to prevent slippage.

The simultaneous rotation of both endless belt portions 250,252 as a result of the single electric drive motor 246 driving the common pulley assembly 248 causes the drive blocks 258,260 simultaneously and in synchronism to be selectively traversed up or down the leadscrews 254,256, depending on the direction of rotation of the drive axle 247 of the electric drive motor 246. Thereby the motor drive assembly 232, including the cross members 132,134, may be traversed along the leadscrews 254,256.

Each leadscrew 254,256 extends through a respective pair of enlarged holes 262,263; 264,265 provided in each of the cross members 132,134 along the opposed longitudinal edges 242,244 of the traverse assembly 23. The opposed ends 270,274,276,278 of the leadscrews 254,256 are rigidly affixed to a respective trunk section 280,282,284,286 (see also FIG. 6), each of which is rigidly attached to the lower surface 131 of the tabletop 10, in particular to the upper torso section 16 thereof.

The trunk sections comprise first and second longitudinally spaced pairs 280,282; 284,286 of the trunk sections, each pair comprising two transversely separated trunk sections. The inner surfaces 268, 270 of the pairs of trunk sections 280,282; 284,286 define the back and forth limits of movement of the cross members 132,134. The upper end portions 288,290,292,294 of the cross members 132,134 are each provided with an annular bearing 296,298,300,302 therein, each bearing 296,298,300,302 defining a respective longitudinal cylindrical cavity 304,306,308,310 extending therethrough. First and second opposed longitudinally directed support rods 312,314 each extend through a respective pair of the cavities 304,306,308,310 into the bearings 296,298,300,302, and each support rod 312,314 is rigidly mounted between a respective two of the longitudinally separated trunk sections 280,284; 282,286. The cross members 132,134, and accordingly the motor drive assembly 232, can thereby slide along the support rods 312,314.

The operation of the traverse assembly 230 will now be described. When the electric drive motor 246 is energized, to operate in either a forward or reverse rotational mode, the endless belt 251 is rotated by the common pulley assembly 248 thereby causing the drive blocks 258,260 to be longitudinally driven up or down the respective leadscrews 254,256. Accordingly, the corresponding trunk sections 280,284; 282 ,286 associated with the leadscrews 254,256, and which themselves are rigidly attached to the upper torso section 16 of the tabletop 10, are longitudinally driven back or forth relative to the column 8 to which the cross members 132,134, and also the motor drive assembly 232, are connected. This traverses the tabletop 10 back and forth relative to the column 8.

In the table traverse belt drive arrangement in accordance with this aspect of the invention, a single motor is employed for driving an endless belt using a pulley belt drive for driving twin leadscrews of each side of the torso section of the tabletop. The use of a single motor control results in a simple construction. Moreover, by providing a single motor which equally drives each longitudinally directed side of the tabletop by a respective belt drive, this obviates problems of the two sides being differently driven (which could occur if two motors are used, one for each side). A single control of the drive of each side is provided, so that each side is driven with an equal pulling force. In combination therewith, the provision of twin leadscrews so that both sides are driven equally prevents a “crabbing” action from occurring under loaded conditions, which could otherwise jam, damage or wear the traverse mechanism. Crabbing otherwise occurs when the traverse forces are not equally applied on both sides of the table, leading to a resultant radial force acting on the table and traverse mechanism, which causes jamming of the mechanism, and wear. The table is often required to be traversed when a patient is lying on the tabletop, and this can cause high loads to be applied to the traverse mechanism, which render it essential that both sides are driven equally. Furthermore, the bearings are toleranced to permit the traverse movement, but also minimising slack or movement in other directions, which could otherwise lead to poor stiffness of the tabletop relative to the column.

A still further aspect of the present invention is directed to an assembly for minimising the possibility of a user's fingers becoming trapped between moving parts of the surgical table 2, in particular between the relatively traversing parts of the tabletop 10, when the tabletop 10 is being longitudinally traversed relative to the column 8 as described hereinabove.

Thus referring to FIG. 6, as a result of the upper torso section 16 being traversable relative to the column 8, longitudinal zones 350,352 exist on opposed longitudinal sides of the column 8 in which a user's fingers could become trapped as either zone 350,352 is progressively decreased in width as a result of traversing of the tabletop 10 in one direction or the other relative to the column 8. Since the surgical table 2 is accessed by medical staff on each of the opposed longitudinal sides of the tabletop 10, an assembly for preventing fingers being trapped is provided on each longitudinal side of the tabletop 10.

It may be seen that a finger trap zone 350,352 exists between the opposed trunk sections 280,282; 284,286 on one longitudinal side or the other of the column 8 and the respective associated cross member 132,134. As the tabletop 10 is traversed longitudinally in one direction or the other, on one side of the column 8 the distance between the respective combination, depending on the direction of movement, of the opposed trunk sections 280,282; 284,286 and the associated cross members 132,134 is progressively decreased until the trunk sections 280,282; 284,286 and the cross member 132,134 are in substantially an abutting relationship. The finger trap switching assembly of this aspect of the invention acts as a cut-out for the electric drive motor 246 should a person's fingers get squeezed between any of the trunk sections 280,282; 284,286 and the associated cross member 132,134 so that the fingers are not trapped or injured.

Referring to FIGS. 10 to 14, a respective finger trap switching assembly 354,356 is provided at each transversely directed edge of the traverse assembly 230. Each finger trap switching assembly 354,356 includes a horizontally oriented movable detector bar 360 in the form of a generally C-shaped member with straight edges. Each detector bar 360 comprises a linear elongate central portion 362 which extends along and parallel to a respective longitudinally directed outer edge 364,366 of the traverse assembly 230, the central portion 362 being mounted at each end thereof through a respective clearance hole 368,370 through a respective cross member 132,134 so as to be oriented in a longitudinal direction relative to the direction of movement of the tabletop 10.

Each end portion 372,374 of the detector bar 360 located longitudinally outwardly of the respective cross member 132,134 is bent back by an angle of 90° so as to extend horizontally and inwardly towards the longitudinal centre line of the traverse assembly 230 of the tabletop 10. Finally each free end 376,378 of the detector bar 360 is bent backwardly at an angle of 90° so as to be horizontal and parallel to the central portion 362 and to extend into a respective second clearance hole 380,382 in the corresponding cross member 132,134. In this way, a horizontal finger-engaging portion 384,386 of the detector bar 360 is provided at each respective outer corner of the traverse assembly 230. Each respective finger engaging portion 384,386 is parallel to and spaced outwardly in a longitudinal direction from the respective outer surface 388,390 of the respective cross member 132,134 to define therebetween a finger safety region 392. The central portion 362 of each detector bar 360 passes on one longitudinal side thereof through a clearance hole 394 provided in the associated drive block 258,260 and on the other longitudinal side thereof through an annular elongate bush 396.

The deflector bar 360 is moved longitudinally by inadvertent finger pressure applied to either of the finger engaging portions 384,386, either by a finger being present in the finger safety region 392, or by a finger being present between a cross member 132,134 and a trunk section 280,284,286,288 and squeezed therebetween, so as to push on the associated finger engaging portion 384,386.

The central portion 362 of the detector bar 360 is provided an actuator member 400 at the longitudinal centre thereof. The actuator member 400 comprises a cylindrical centre part 402 having a cylindrical outer surface 404 which is located between two opposed inwardly facing frustoconical parts 406,408, each having a frustoconical outer surface 410,412 of progressively increasing radius going away from the centre part 402, and two opposed cylindrical end parts 414,416 having a cylindrical outer surface 418,420, each cylindrical end part 414,416 being located adjacent the large diameter edge of a respective frustoconical part 406,408. If desired, the actuator member may be formed by machining a single metallic body. A pair of helical compression springs 422,424 is disposed about the central portion 362 of the detector bar 360, between the cylindrical end parts 414,416 either one of the drive blocks 258,260 or one of the bushes 396. In this way, the actuator member 400 is biased by the helical compression springs 422,424 into a central location between the cross members 132,134.

A micro-switch 426 is mounted on the floor 236 of the traverse assembly 230 and includes a switch member 428 which is biased about a pivot 430 mounted on a micro-switch body 432 SO as to bear against the outer surface 404 of the centre part 402 of the actuator member 400. If the actuator member 400 is moved either back or forth in a longitudinal direction by corresponding longitudinal movement of the deflector bar 360, the switch member 428 is pushed inwardly towards the micro-switch body 432 against the bias at the pivot 430 by one or other of the frustoconical outer surfaces 410,412, thereby tripping the micro-switch 426 and causing the electric drive motor 436 to be switched off instantaneously. This would immediately terminate the traversing movement of the tabletop 10. A variety of alternative switching devices will be apparent to those skilled in the art.

Accordingly, if a user's fingers were to become located between the outer surface 388,390 of a cross member 132,134 and the inwardly directed surface of the finger engaging portion 384,386 of the detector bar 360, any finger pressure causing the detector bar 360 to be moved relative to the associated cross member 132,134 would cause the micro-switch 426 to be tripped. Alternatively, if a user's fingers were to become trapped between a trunk section 282,284,286,288 and the associated finger engaging portion 384,386 of the detector bar 360, finger pressure on the finger engaging portion 384,386 would move the detector bar 360 in the opposite direction and cause the micro-switch 426 also to be tripped.

The finger trap switching assembly in accordance with this aspect of the invention provides the advantages that the control switch arrangement is provided to halt the traverse movement before an accident can happen, but nevertheless this is achieved by only requiring a minimal reduction in the traverse distance of the tabletop as a result of the finger trap switching assembly being provided. The finger trap switching assembly has a simple construction and provides two modes for protection of the fingers of a user, thereby greatly enhancing the safety of the traverse mechanism

A yet further aspect of the present invention concerns the structure and operation of castors and wheels and associated locking devices therefor on the base 4 of the surgical table 2.

Referring to FIGS. 15 to 18, the chassis 50 of the base 4 has mounted thereon at one end 400, in the direction of the leg section 20, a pair of front fixed wheels 402,404, each of which wheels 402,404 is mounted about a respective fixed axis 406,408 at a respective longitudinal edge part 410,412 of the chassis 50. The front fixed wheels 402,404 are provided to assist in achieving straight-line movement of the surgical table when it is pushed from the rear end. At the other, rear, longitudinal end 414 of the chassis 50 is provided, on opposed longitudinal sides 416,418 of the chassis 50, a pair of swivel castor wheels 420,422. The swivel castor wheels are provided at the rear of the surgical table 2 so as to assist positioning of the surgical table 2 in the desired location, and to assist in the surgical table 2 being pushed from a rearwardly direction other than in a straight line movement.

The surgical table 2 is additionally provided with further castors and locking mechanisms not only to lock the table 2 securely in position when used during surgery, but also to enable the position of the table 2 finely to be adjusted at the desired position.

Accordingly, at the front end of the table 2, inwardly located in longitudinal direction relative to the front fixed wheels 402,404, are provided a pair of front castors 428,430. Each of the front castors 428,430 is mounted on and depends downwardly from a horizontal plate member 432, extending transversely across the width of the chassis 50. The plate member 432 has holes 434,436 therein though which extend upwardly directed guide pins 438,440, each guide pin 438,440 being located on a respective side of a central longitudinal axis of the surgical table 2. The plate member 432 can move upwardly and downwardly relative to the guide pins 438,440.

When it is necessary finely to position the surgical table 2, the front castors 428,430 are lowered by a front castor lowering mechanism, designated generally as 442, which is arranged to apply a downwardly directed force onto the top surface 446 of the plate 432. The lowering mechanism 442 comprises a horizontally oriented shaft 444 which is provided at one end thereof with a foot operated pedal 446 and is supported adjacent to the pedal 446 by an annular bearing 448 disposed in an upwardly extended pedal support member 450 connected to the upper surface of the chassis 50. A middle part of the shaft 444 is also supported in an annular bearing 452 provided in a second support member 454 extending upwardly from the upper surface of the chassis 50. The other end of the shaft 444 is rotatably mounted in a further annular bearing 456 in a third support member 458 extending upwardly from the upper surface of the chassis 50.

The second and third support members 454,458 are located on opposed sides of the plate member 432 and above the plate member 432 a roller bearing 460 is eccentrically mounted relative to the axis of the shaft 444, the roller bearing 460 having an axis parallel to that of the shaft 444. The roller bearing 460 is free to rotate but translationally rigidly attached to the shaft 444 by a pair of opposed arms 464,466 located at opposed ends of the roller bearing 460.

The foot operated pedal 446 has a foot engageable part 468 located at an end of an arm 470 extending away from a hub 472 of the pedal 446 which is connected to the end of the shaft 444. The length of the arm 470 is selected so that it is significantly longer than the radial distance of the roller bearing 460 from the shaft 444. This provides a high degree of mechanical advantage when the foot pedal 446 is operated by foot pressure applied to the foot engageable part 468 which rotates the shaft 444 and in turn causes the roller bearing 460 to push downwardly on the plate member 432. This foot pressure thereby urges the front castors 428,430 downwardly into engagement with the floor 6 and correspondingly to continue to lift the front end of the surgical table 2 so that the front fixed wheels 402,404 are lifted free of the floor 6.

The high degree of mechanical advantage of the pedal 446 and roller bearing 460 in combination provides a significant benefit because, as will be apparent to those skilled in the art, in order to make the front castors 428,430 take the load of the table 2 and a patient thereon instead of the front fixed wheels 402,404, it is necessary to lift the entire front end of the surgical table 2, including a proportion of the weight of the table 2 and of the weight of the patient lying on the table 2.

In order to keep the front castors 428,430 in a downward position, a locking bracket 474 is mounted on the chassis 50 which extends in a longitudinally facing direction away from the front end of the chassis 50. The locking bracket 474 provides a downwardly directed locking surface 476 against which an upwardly directed surface 478 of the arm 470 may be urged, by the weight of the table 2, so as to retain the arm 470 in a downwardly pressed position. The pedal arm 470 can readily be released again from the bracket 474 by pressing down and twisting the pedal 446 outwardly away from the bracket 474 by the application of foot pressure in order to lower the table 2 again onto the fixed front wheels 402,404 and raise the front castors 428, 430 again.

This accordingly provides a simple pedal locking mechanism that can easily be operated by a user using one foot, particularly whilst wearing lightweight footwear typically used in operating theatres and hospitals. Also, a hydraulic or gas-damped damper provides damping when lowering the table 2 again onto the fixed front wheels 402,404, thus avoiding excessive shock transfer to any patient on the table 2.

At the rear end of the table 2, inwardly located in longitudinal direction relative to a pair of fixed feet 490,492 in the form of pads, are located the pair of rear castors 420,422. Like the front castors 428,430, each of the rear castors 420,422 is mounted on and depends downwardly from a horizontal plate member 532 extending transversely across the width of the chassis 50. The plate member 532 has holes 534,536 therein though which extend upwardly directed guide pins 538,540, each guide pin 538,540 being located on a respective side of a central longitudinal axis of the surgical table 2. The plate member 532 can move upwardly and downwardly relative to the guide pins 538,540. In this configuration, the rear of the table 2 rests on the floor 6 by the fixed feet 490,492 so that the table 2 is securely positioned on the floor 6.

When it is necessary to move the surgical table 2, the rear castors 420,422 are lowered by a rear castor lowering mechanism, designated generally as 542, which is arranged to apply a downwardly directed force onto the top surface 546 of the plate 532. The lowering mechanism 542 has substantially the same construction and operation as the front castor lowering mechanism 442 described hereinabove.

Thus the rear castor lowering mechanism 542 comprises a horizontally oriented shaft 544 which is provided at one end thereof with a foot operated pedal 546 and is supported adjacent to the pedal 546 by an annular bearing 548 disposed in an upwardly extended pedal support member 550 connected to the upper surface of the chassis 50. The two pedals 446,546 are disposed at a common longitudinal edge of the base 4 so that each pedal can readily be accessed by an operator standing at one side of the table 2. The other end of the shaft 544 is rotatably mounted in a further annular bearing 556 in a third support member 558 extending upwardly from the upper surface of the chassis 50.

The first and third support members 550,558 are located on opposed sides of the plate member 532 and above the plate member 532 a roller bearing 560 is eccentrically mounted relative to the axis of the shaft 544, the roller bearing 560 having an axis parallel to that of the shaft 544. The roller bearing 560 is free to rotate but translationally rigidly attached to the shaft 544 by a pair of opposed arms 564,566 located at opposed ends of the roller bearing 560.

The foot operated pedal 546 has a foot engageable part 568 located at an end of an arm 570 extending away from a hub 572 of the pedal 546 which is connected to the end of the shaft 544. The length of the arm 570 is selected so that it is significantly longer than the radial distance of the roller bearing 560 from the shaft 544. This provides a high degree of mechanical advantage when the foot pedal 546 is operated by foot pressure applied to the foot engageable part 568 which rotates the shaft 544 and in turn causes the roller bearing 560 to push downwardly on the plate member 532. This foot pressure thereby urges the rear castors 420,422 downwardly into engagement with the floor 6 and so as to lift the rear end of the surgical table 2 so that the fixed feet 490,492 are lifted free of the floor 6.

The rear castor lowering mechanism has, like the corresponding front castor mechanism, a high degree of mechanical advantage of the pedal 546 and roller bearing 560 in combination.

In order to keep the rear castors 420,422 in a downward position, a locking bracket 574 is mounted on the chassis 50 which extends in a longitudinally facing direction away from the rear end of the chassis 50. The locking bracket 574 provides a downwardly directed locking surface 576 against which an upwardly directed surface 578 of the arm 570 may be urged, by the weight of the table 2, so as to retain the arm 570 in a downwardly pressed position. The pedal arm 570 can readily be released again from the bracket 574 by pressing down and twisting the pedal 546 outwardly away from the bracket 574 by the application of foot pressure in order to lower the table 2 again onto the fixed feet 490,492.

Again, a hydraulic or gas-damped damper is provided at the rear end as at the front end to damp the movement of the table when it is lowered onto the fixed feet.

1. A surgical table comprising a base for standing on a floor, a column of adjustable height mounted on the base, a tabletop providing a patient support surface, a movable framework mounted between the tabletop and the column for enabling at least a part of the tabletop to be rotatable about two orthogonal axes, the movable framework comprising first and second frame portions of the framework, and first and second actuators, each actuator being connected to a respective frame portion for moving the respective frame portion about a respective axis:

2. A surgical table according to claim 1 wherein the first frame portion is rotatably mounted on the column about a first axis and the second frame portion is rotatably mounted on the first frame portion about a second axis and is connected to the tabletop.

3. A surgical table according to claim 2 wherein the first frame portion is disposed within the second frame portion and the first frame portion surrounds a top part of the column.

4. A surgical table according to claim 2 wherein the first frame portion is rotatably mounted on the column by two first pivot joints on opposed sides of the column.

5. A surgical table according to claim 4 wherein the two first pivot joints are located at a height below the top of a lifting mechanism for the column.

6. A surgical table according to claim 4 wherein the second frame portion is rotatably mounted on the first frame portion by two pivot joints which are on opposed sides of the first frame portion.

7. A surgical table according to claim 1 wherein each of the first and second actuators comprises a fixed body part mounted on one of the column and the respective frame portion and a movable elongate part connected to the other of the column and the respective frame portion.

8. A surgical table according to claim 7 wherein for at least one frame portion the movable elongate part is connected to the respective frame portion by a universal joint.

9. A surgical table according to claim 8 wherein each frame portion is rectangular and the movable elongate part is connected to a corner part of the respective frame portion

10. A surgical table according to claim 7 wherein the fixed body part of each actuator is mounted on a frame of the column which is adapted to change height together with the tabletop when the height of the tabletop is adjusted.

11. A surgical table according to claim 1 wherein the tabletop is attached to opposed longitudinally directed members of the second frame portion.

12. A surgical table comprising a base for standing on a floor, a column of adjustable height mounted on the base, a tabletop providing a patient support surface, and a hinge mechanism between the top of the column and the tabletop to enable the tabletop to be hinged upwardly to reveal the top of the column and the underside of the tabletop.

13. A surgical table according to claim 12 wherein the hinge mechanism has a hinge axis transverse to the longitudinal direction of the tabletop.

14. A surgical table according to claim 13 wherein the hinge mechanism is mounted on the underside of the tabletop at a position selected to provide substantially equal portions of the weight of the tabletop on opposed sides of the hinge mechanism.

15. A surgical table according to claim 12 wherein the hinge mechanism is mounted to a pair of longitudinally oriented members mounted on the underside of the tabletop and to a movable framework which is mounted between the tabletop and the column for enabling at least a part of the tabletop to be rotatable about two orthogonal axes.

16. A surgical table according to claim 12 wherein the surgical table further comprises at least one catch member between the table and the column for selectively locking the tabletop in a down position.

17. A surgical table according to claim 16 wherein the hinge mechanism and the at least one catch member are located at opposed transverse sides of the column.

18. A surgical table comprising a base for standing on a floor, a column of adjustable height mounted on the base and a tabletop providing a patient support surface, the column comprising an inner column portion mounted on the base and including a lifting mechanism, an outer column portion having a top part mounted to a movable top part of the inner column and movable therewith, the outer column portion being connected to the tabletop, and a slider assembly between the inner and outer column portions.

19. A surgical table according to claim 18 wherein the slider assembly comprises a plurality of slider members mounted on one of the inner and outer column portions which are arranged to slide over at least one surface of the other of the inner and outer column portions.

20. A surgical table according to claim 19 wherein the slider members are mounted on the inner surface of the outer column portion and bear against the outer surface of the inner column portion.

21. A surgical table according to claim 20 wherein the slider members are mounted along a lower edge of the outer column member.

22. A surgical table according to claim 19 wherein the outer column portion is tubular and the slider members are mounted around the inner surface of the tube.

23. A surgical table according to claim 19 wherein the slider members comprise plastics pads.

24. A surgical table according to claim 23 wherein the plastics is acetal homopolymer.

25. A surgical table according to claim 23 wherein the plastics pads are mounted in adjustable mounts so that the plastics pads are adjustable to compensate for wear of the pads.

26. A surgical table according to claim 18 wherein the outer column portion is mounted to the inner column portion by a horizontal plate which is affixed to a horizontal top surface of the lifting mechanism and to an upper peripheral edge of the outer column portion.

27. A surgical table comprising a base for standing on a floor, a column of adjustable height mounted on the base, a tabletop providing a patient support surface, and a tabletop traverse drive mechanism for moving the tabletop relative to the column in a selected longitudinal direction of the tabletop.

28. A surgical table according to claim 27 wherein the tabletop traverse drive mechanism comprises a motor, a pair of drive elements for being driven by the motor, and a pair of traverse devices, each respective traverse device being located at a respective longitudinal edge of the tabletop, each drive element being adapted to drive a respective traverse device.

29. A surgical table according to claim 28 wherein each traverse device comprises an elongate first coupled member extending in a longitudinal direction of the tabletop, a body movable along the first coupled member and an annular second coupled member mounted in the body and surrounding and engaging with the first coupled member, the respective drive element connecting with the second coupled member.

30. A surgical table according to claim 29 wherein the first and second coupled members are threaded and are meshed together.

31. A surgical table according to claim 29 wherein the motor, the pair of drive elements, the pair of bodies and the pair of second coupled members are mounted in a common frame.

32. A surgical table according to claim 29 wherein the common frame is connected to the column, and the first coupled members are connected to the tabletop.

33. A surgical table according to claim 29 wherein the pair of drive elements comprise portions of a common endless belt and the motor includes a pulley assembly for simultaneously driving the endless belt.

34. A surgical table according to claim 33 wherein the endless belt has a profiled inner surface mating with a corresponding profiled outer surface of each second coupled member.

35. A surgical table according to claim 29 wherein a respective slider bar is mounted parallel to each first coupled member.

36. A surgical table according to claim 35 wherein each first coupled member and the associated slider bar are mounted between a respective pair of support blocks which are connected to the tabletop.

37. A surgical table comprising a base for standing on a floor, a column of adjustable height mounted on the base, a tabletop providing a patient support surface, the tabletop being movable relative to the column in at least one selected direction of the tabletop and a finger safety device for protecting the fingers of a user from being trapped between the tabletop and the column during relative movement therebetween.

38. A surgical table according to claim 37 wherein the finger safety device comprises a movable element disposed adjacent one of two opposed surfaces which can move together when the tabletop and the column are moved together, and the movement of the tabletop and the column being disabled when the element is moved.

39. A surgical table according to claim 38 wherein the element is spaced from the said one surface by a particular distance so as to be moved when a user's finger is pushed therebetween.

40. A surgical table according to claim 38 wherein the movable element is provided at each opposed side, with reference to the movement of the tabletop, of the column on each opposed longitudinal edge of the tabletop.

41. A surgical table according to claim 40 wherein a pair of the movable elements is comprised in a respective common detector device for each longitudinal edge of the tabletop.

42. A surgical table according to claim 41 wherein the common detector device comprises a bar having a central portion carrying a switch actuator, and two opposed end portions, each of which comprises a respective movable element, the switch actuator engaging with a switch device whereby movement of the bar in either longitudinal direction causes the switch device to be tripped.

43. A surgical table according to claim 42 wherein the common detector device is mounted between opposed walls of a frame and further comprises a pair of opposed biasing elements for biasing the switch actuator to a central position.

44. A surgical table according to claim 43 wherein the end portions of the bar are horizontally oriented and extend inwardly towards the central longitudinal axis of the tabletop spaced from respective transversely directed outer surfaces of the respective opposed walls.

45. A surgical table according to claim 42 wherein the switch actuator comprises a profiled surface having a central part, and two outer parts, a dimension of the parts progressively increasing from the central part to the outer parts whereby the switch device is moved to trip the switch when the switch device is moved from the central part.

46. A surgical table according to claim 45 wherein the profiled surface also has two intermediate parts between the central part and the outer parts, each intermediate part being on a respective opposed side of the central part.

47. A surgical table comprising a base for standing on a floor, a column of adjustable height mounted on the base and a tabletop providing a patient support surface, the base having first and second opposed ends, a plurality of longitudinally oriented fixed wheels at the first end and a plurality of first castors at the second end for permitting the table to be moved over a floor, a plurality of second castors at the first end, a first moving mechanism for moving the second castors between an upper retracted position and a lower active position, in the lower position the second castors being lower than the fixed wheels whereby the fixed wheels are retracted from the floor, a plurality of fixed feet at the second end and a second moving mechanism for moving the first castors between an upper retracted position and a lower active position, in the lower position the first castors being lower than the fixed feet whereby the fixed feet are retracted from the floor.

48. A surgical table according to claim 47 wherein at least one of the moving mechanisms includes a horizontal member from which the respective castors depend downwardly, at least one guide member for guiding vertical movement of the horizontal member between upper and lower positions and an actuator for selectively applying a downwardly directed force to the horizontal member to move the respective castors to the lower active position.

49. A surgical table according to claim 48 wherein the actuator comprises a bearing member eccentrically mounted on a first end of a rotatable shaft member, the bearing member having a bearing surface acting on the upper surface of the horizontal member, an arm mounted on and extending radially away from an opposed second end of the shaft member and a pedal member mounted on an end of the arm remote from the shaft.

50. A surgical table according to claim 49 wherein the bearing member comprises a roller bearing and the horizontal member is a plate.

51. A surgical table according to claim 48 wherein the at least one guide member comprises a plurality of upwardly directed guide pins extending through respective holes in the plate.

52. A surgical table according to claim 48 wherein the at least one moving mechanism further comprises a locking mechanism for locking the actuator in a downward position and to retain the respective castors in the lower active position.

53. A surgical table according to claim 52 wherein the locking mechanism includes an outwardly extending bracket mounted on the base and providing a downwardly facing locking surface against which an upper surface of the arm is selectively retained.

54. A surgical table according to claim 48 wherein the least one moving mechanism further includes a damping device for damping the movement of the base when the respective castors are retracted.

55. A surgical table according to claim 54 wherein the damping device comprises a hydraulic damper.

56. A surgical table according to claim 47 wherein the to moving mechanisms have the same structure and pedals for operating the two moving mechanisms are disposed at a common longitudinal edge of the base.
